(19) United States
(12) Patent Application Publication
(10) Pub. No.: US 2014/0006110 A1
(43) Pub. Date: Jan. 2, 2014

(54) STRUCTURAL SIZE ESTIMATION MODEL FOR EAI PROJECTS

(71) Applicant: Infosys Limited, Bangalore (IN)

(72) Inventor: Manjula Natarajan, Chennai (IN)

(73) Assignee: Infosys Limited

(21) Appl. No.: 13/929,529

(22) Filed: Jun. 27, 2013

(30) Foreign Application Priority Data
Jun. 29, 2012 (IN) 2608/CHE/2012

(51) Int. Cl. G06Q 10/06

(52) U.S. Cl. CPC G06Q 10/0637
USPC 705/7.36

(57) ABSTRACT

Size of an enterprise application integration project can be determined by based on data exchange activities, data processing activities, other systemic requirements for the integration and associated weights. Data exchanges and processing activities can be categorized as reception, validation, transformation, publishing, enrichment, or other activities. Activities can be further divided into sub-activities based on complexity of integration tasks. A total project build size can be obtained based on numbers of sub-activities and associated weights. Typically, weights are software vendor dependent, and a total build size is determined as a summation of a product of numbers of sub-activities and associated vendor specific weights.

### FIELD

The disclosure pertains to method and apparatus for estimating Enterprise Application Integration project sizes.

### BACKGROUND

Enterprise Application Integration (EAI) projects aim to integrate a host of application systems built on disparate technologies. The integrated solution should have the ability to extend the interfacing capabilities across technologies and help achieve seamless interoperability.

Integration projects are characterized by a host of complexity factors such as the participating systems, the underlying technologies, data interfacing complexities, and preparing and presenting data for the participating applications. Hence the associated challenges in sizing EAI projects are twofold: 1) assessing the functional characteristics such as synchronous or asynchronous data exchange requirements and data processing requirements, and 2) assessing implementation characteristics. Traditional estimation models fail to integrate architectural complexity factors along with runtime functional integration complexities. In view of the failure of conventional estimation models, alternative approaches to EAI project estimation are needed.

### SUMMARY

Methods and apparatus are disclosed that permit reliable estimation of enterprise application integration project size so that the resources required for a project can be adequately anticipated. In some examples, methods, implemented at least in part by a computing device, for determining a build size of an enterprise application integration project comprise enumerating a number of inter-application data exchange instance definitions, data processing instance definitions and other systemic complexity instance definitions associated with at least two applications to be integrated. Complexity factors for the inter-application data exchange instances, data processing instances and other systemic complexity instances are obtained, and a build size of the enterprise application integration project is determined based at least on the number of inter-application data exchange instance definitions, data processing instance definitions and other systemic complexity instance definitions, and the associated complexity factors. In some examples, one or more of the inter-application data exchange instance definitions are characterized as at least one of a reception exchange instance definition, or a publishing exchange instance definition, while one or more of the data processing instance definitions are characterized as at least one of a validation instance definition or a transformation instance definition or a data enhancement instance definition

In some embodiments, calculating the build size of the enterprise application integration project is based at least on the number of inter-application data exchange instance definitions, the number of data processing instance definitions, other systemic complexity definitions and the associated complexity factors as a summation of products of numbers of the instance definitions and associated weights. In representative examples, at least one or more weights are based on data encryption, data authentication, or data validation requirements. In other examples, at least one or more weights are based on error handling, event handling, data merging, or data transformation requirements associated with at least one enumerated exchange instance definition. In some examples, a selection of the one or more weights is received from a standard weight album, wherein the standard weight album contains a pre-defined plurality of weights available for data exchange, data processing and systemic complexity instance definitions. In other examples, one or more computer-readable media comprise computer-executable instructions for causing a computing device to perform any of these methods.

Sizing frameworks, implemented at least in part by a computing device, for determining a size of an enterprise application integration project, comprise a repository of one or more activity categories and associated sub-categories, wherein each of the one or more associated sub-categories has a corresponding weight. A repository of data exchange interfaces associated with the applications to be integrated includes numbers of such interfaces. In some examples, the activity categories are based on data processing associated with the data exchanges. In further examples, the activity categories include two or more of data reception, data publishing, data transformation, data validation, and data enrichment. In some examples, sub-activities associated with data reception are based on a data format associated with a data request, wherein the data format can include XML or data streams. In some embodiments, sub-activities associated with data transformation are based on string manipulations associated with the data transformation.

Computer implemented interfaces for estimating a build size of an enterprise application integration project comprise a data display area configured to display an activity category list that includes categories associated with data reception, data publishing, data transformation, and validation. A data input area includes data category input areas configured to receive indications of numbers of activities in each activity category. An output data area is configured to display a build size based on the numbers of activities. In some examples, an activity type display area is configured to display activity complexity types. In other examples, an activity output area is configured to display a build size associated with each of the activity complexity types. In other embodiments, the activities comprise data routing and data enrichment. In still further examples, the activity output area is configured to display a build size associated with each of the activity complexity types based on a product of numbers of activities of each type and weights assigned to the activity types.

The foregoing and other features and advantages of the invention will become more apparent from the following detailed description, which proceeds with reference to the accompanying figures.

### BRIEF DESCRIPTION OF THE DRAWINGS

FIG. 1 is a flowchart showing an exemplary method for determining a size of an enterprise application integration (EAI) project.

FIG. 2 is a diagram showing a framework for determining a size of an EAI project.

FIG. 3 is diagram showing representative communication paths between applications and interfaces.

FIG. 4 illustrates a representative message processing associated with an EAI project.

FIG. 5 is a diagram illustrating a representative size estimation based on data exchange and data processing requirements.

FIGS. 6A-6B illustrate activity identification and weighting in a representative application of the disclosed methods and apparatus.

FIGS. 7A-7C illustrate activity identification and weighting in another representative application of the disclosed methods and apparatus.

FIG. 8 illustrates representative business services and operations for an example integration project.

FIGS. 9A-9C illustrate a representative determination of activity weights.

FIGS. 10A-10C illustrate a worksheet for determination of project size for the example project.

FIG. 11 illustrates a user interface for selection of one or more activities for inclusion in project sizing.

FIG. 12 illustrates a user interface for selection of vendor specific weights for use in project sizing.

FIG. 13 is a block diagram illustrating an example of a computing environment that can be used to implement any of the technologies described herein.

FIG. 14 is a schematic diagram illustrating EAI project sizing considerations.

### DETAILED DESCRIPTION

As used in this application and in the claims, the singular forms “a,” “an,” and “the” include the plural forms unless the context clearly dictates otherwise. Additionally, the term “includes” means “comprises.”

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. Also, the terms “Enterprise Application” and “Application” used in the description are interchangeable Representative methods and apparatus for EAI project size estimation are disclosed herein. Such methods and apparatus can be used in conjunction with business process integration, BPM (Business Process Management) service oriented architectures (SOAs), product based solutions, package implementations, and system and network integrations. Method weights are generally dependent on specific vendor software products, and vendor dependence is noted in some examples. Typically, project complexity and weighting as discussed below can be based on the properties of such products as used in an EAI project, or based on historical data associated with projects using such In an EAI project, data exchanges are defined based on integration architectures. For convenience, “data exchange instance definition” as used herein refers to a particular data exchange type associated with an architectural point. As such, such an “instance” is to be distinguished from use of the term “instance” to refer to an object instantiated based on a particular class.

### Example 1

### Model Framework

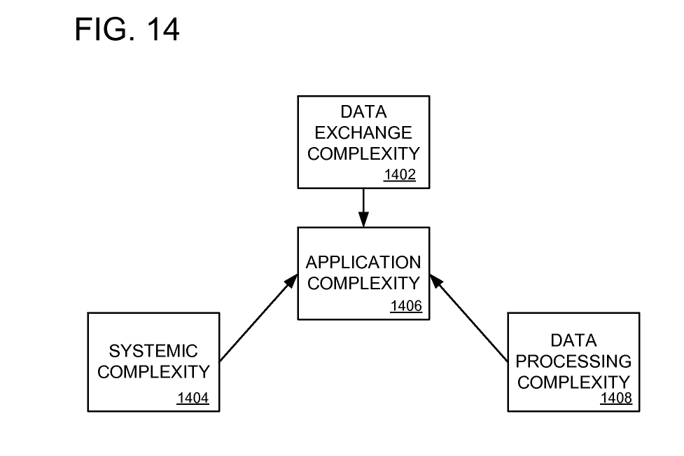

EAI project sizing generally targets costs of project development and implementation. Such sizing can address both the business functionality being implemented, i.e., what task the integrated components are to perform, and the technical implementation of the business functionality, i.e., how the components perform. Such sizing can be based on interfaces, data structures, and data processing requirements associated with application integration as depicted in FIG. 14. Data exchange complexity 1402, systemic complexity 1404, and data processing complexity 1408 can be considered to arrive at an application complexity 1406 as described in detail below.

Structural estimation methodology can be based on features and aspects of software-architectural layers associated with an EAI project or other integration project. Typically, functional factors attributable to some or all layers and the associated implementation complexities are considered. For example, sizing is obtained based on an additive model relating to project requirements associated with data exchange, data processing, along with additional systemic complexities. The implementation complexities are determined for some or all of these requirements to determine numbers of instances. Complexity of identified instances can be estimated based on one or more weighting factors that can be associated with one or more aspects of the identified instances. For example, a total EAI estimate can be based on a project size estimate as a sum of products of numbers of data exchange units, data processing units, and systemic complexity units and respective weight units. Such a methodology can be refined by validation after project completion to compare estimated and actual total project sizes. In particular, the failure to identify project units can be investigated along with reliability of some or all weight factors.

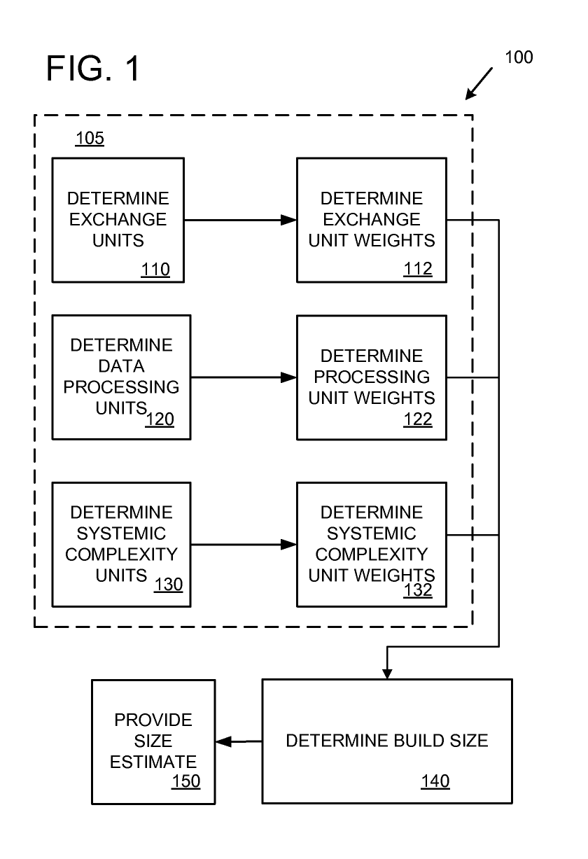

A representative method is illustrated in FIG. 1. At 105, project requirements are assessed. For example, a number of exchange units is determined at 110, and exchange weights are determined at 112 based on data exchange complexity or based on historical validations of prior projects. A number of data processing units and a number of systemic complexity units are determined at 120, 130 and respective weights are determined at 122, 132. Unit numbers and weights are combined to determine a total build size at 140, and a size estimate is provided at 150.

### Example 2

### Representative Complexity Sizing

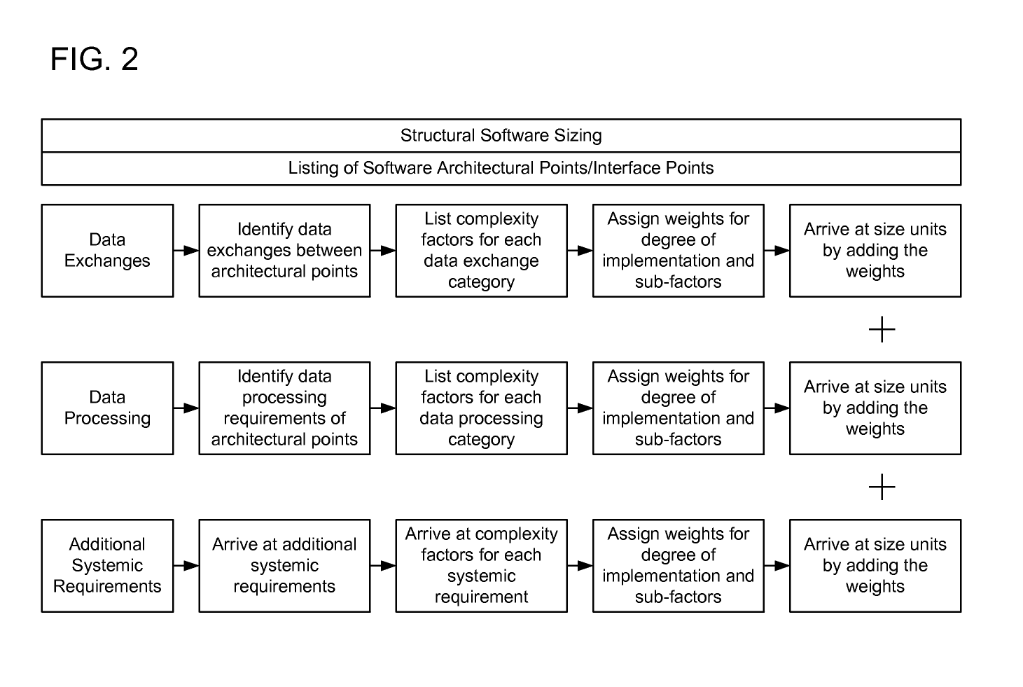

With reference to FIG. 2, a representative project sizing application includes categorizing project integration activities as data exchange, data processing, or additional systemic requirements. Activities in each of these categories are then itemized and weighted. For example, data exchange can be identified based on data exchange requirements between architectural points. In project sizing, the frequency with which such exchanges are performed by system users is generally not relevant, but each architectural point and its associated requirements should be identified. A number of data exchanges to be addressed in an integration project can be associated with the architectural points. Such data exchange points can be referred to as data exchange instances. Complexities of differing data exchanges can be listed so that suitable weights can be assigned based on complexity factors. Total project size units associated with data exchange instances can be obtained as a sum of products of assigned weighting factors for the data exchanges and numbers of data exchanges.

Size units for data processing associated with architectural points can be similarly obtained based on data processing requirements, complexity factors, and the data processing instances. A total size can be obtained as a sum of products of assigned weighting factors for the data processing instances and numbers of corresponding processing instances. Size units for additional systemic requirements can be determined as a sum of products of a number of such factors times a respective weight. A total project size is then obtained as a sum of data exchange, data processing, and additional systemic requirement weights.

### Example 3

### Itemization of Software Architectural Points

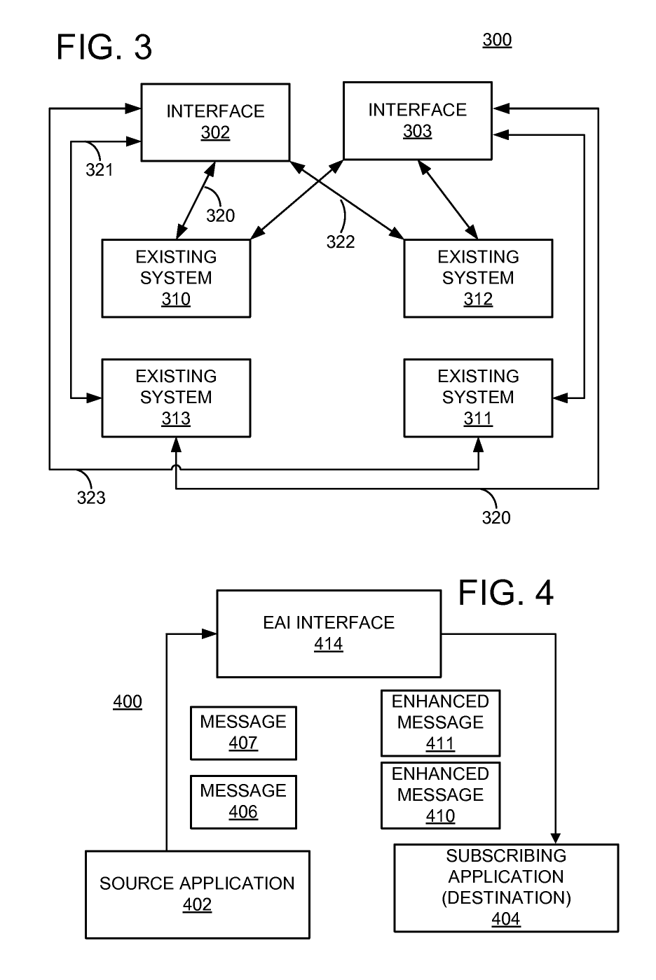

Software architectural points are identified based on the systems to be integrated and interfaces used for integration. A representative system is shown in FIG. 3 that includes four existing systems 310-313 that are to be integrated based on two interfaces 302, 303. Activities associated with data exchanges along some or all of the data paths 320-323 and all other data paths can be considered.

### Example 4

### Data Exchange and Data Processing Itemization of Each Building Block

Building blocks or software architectural points generally have an associated data exchange requirement. For example, data must be delivered to update or modify subscriber databases, or data extracted from source databases. In other examples, data from one or more architectural data points or other interfaces is subscribed to. Examples typical of many EAI projects include data received from external sources, or from storage, data to be published to external sources, or delivered to storage or logged. Logical collection and exchange of processed data can involve data mapping, data enrichment, data transformation, data extraction, data encryption and decryption, synchronization, validation, and business transaction processing.

With reference to FIG. 4, a source application 402 can send messages (a data exchange activity) which are to be processed/enhanced (a data processing activity) and transmitted (a data exchange activity) to a subscribing application 404. For example, messages 406, 407 can be sent or data retrieved via the source application 402, and delivered to a subscribing application 404 as enhanced messages 410, 411. Typically, an EAI interface 414 requests, processes/enhances, validates, or controls other activities associated with data delivery (or other data exchanges) with the subscribing application 404. Of course, in typical practical examples, more than two applications can be integrated, and the two application example of FIG. 4 is provided for convenient illustration.

### Example 5

### Complexity Factors for Data Exchange/Data Processing

Complexity factors associated with one or more or all data exchanges/data processings can be determined. Typical considerations include the extent of metadata preparation required, data exchange/transport mechanisms, and data routing and routing conditions. For example, an EAI interface receives Purchase Order details from a legacy Purchase Order processing system. Complexity factors to be considered during data reception can include: preparation of schema or metadata to receive order data, size of metadata as a number of data elements, configuration of data reception through appropriate adapter or end point and channel, any necessary extraction logic and data parsing.

For data processing requirements, complexity factors can be estimated based on whether data processing can be executed by directly configuring the integration product, using commercial off-the-shelf (COTS) utilities, using custom logic, or a combination of the above approaches.

### Example 6

### Additional Systemic Requirements and Complexities

Typical data-subscribing applications in a business to business (B2B) or other scenario may require that an EAI interface communicate data in an encrypted form. Additional requirements may include communicating data in chunks or a predetermined or variable size and which typically are to be received in a logical sequence and reassembled. An EAI layer can address such additional requirements which are neither direct data exchange requirements nor data processing requirements. Such systemic requirements can be broadly characterized as those associated with additional technical requirements for seamless integration.

### Example 7

### Weight Assignment

Additional factors to be considered can include the degree of customization needed. For each of the complexity factors considered, associated sub-factors need to be analyzed based on how the complexity factor is to be implemented using an integration product. For most of processing and exchange requirements, the implementation may be facilitated using in-built product features, or by using commercial off-the-shelf (COTS) utilities, or through custom development. The degree of implementation can be evaluated for each complexity factor and weights assigned accordingly.

### Example 8

### Exemplary Data Exchange/Processing Size Estimates

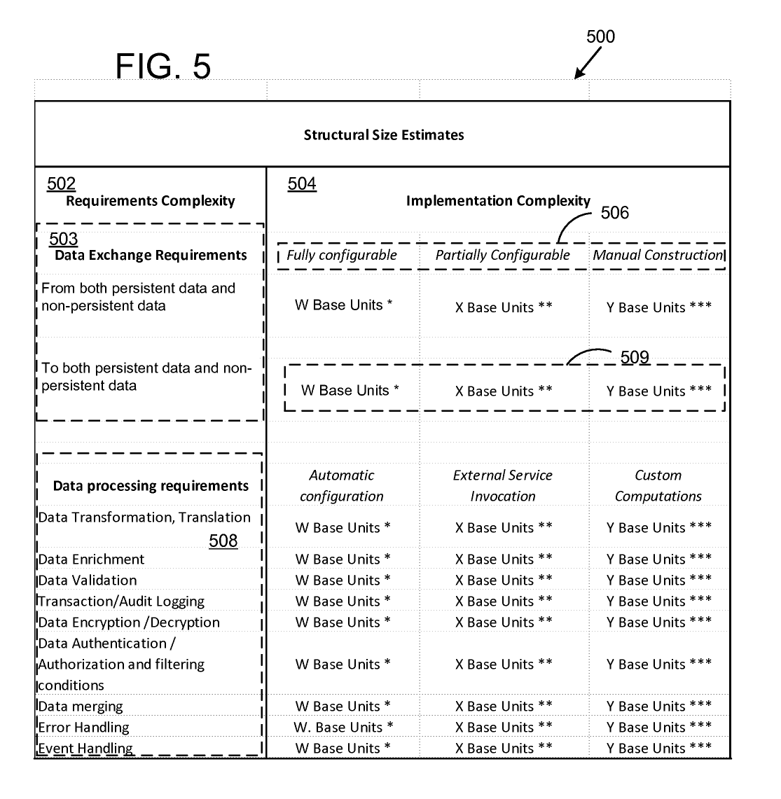

FIG. 5 illustrates a representative size summary table 500 associated with project sizing for data exchange and data processing. Tabulations 502, 504 associated with so-called requirements complexity and implementation complexity can be used to assess project size. In the example of FIG. 5, data exchanges based on reading and writing associated with persistent and non-persistent data are enumerated in a data exchange list 503. Each of the identified data exchanges can be categorized as fully configurable, partially configurable, or manually constructed as provided in a summary list 506, and each category assigned a suitable weight. As shown in FIG. 5, the weights for these categories are shown as W, X, and Y, respectively. A fully configurable data exchange is generally associated with a data exchange in which the exchanging applications or interfaces require minimal data reconfiguration to be compatible with a target application. Manual construction typically requires development and implementation of additional instructions so that data conforms to the target requirement. Accordingly, the weight Y>X. Partial configurability is associated with data exchanges in which some data portions require little additional processing, but preprocessing of other data portions is necessary.

A representative sample of data processing is provided in a data processing requirements list 508. These requirements can also be weighted based on application interfacing capabilities and other processing capabilities in representative categories 509. Certain requirements can be handled automatically based on predetermined application or interface functionalities and product features, while in other examples, external services can be invoked to fulfill requirements. In still other situations, processing requirements require custom processing (and likely the development of instructions for such additional processing).

As shown in FIG. 5, Base Units (noted as *) are defined in view of EAI product complexity, and are typically vendor dependent. Absolute values of weights are generally in a range of from about 0.1 to 10, but other ranges can be used as may be convenient. X Base Units (noted as **) are defined by the base EAI product complexity and external procedure complexity. Thus, sizing is arrived as a product of Base Units and an enhancement factor X so that EAI product complexity can be scaled for a project. The Y Base Units (noted as ***) are defined by the Base Units and an enhancement factor Y associated with customization language complexity.

### Example 9

### Exemplary Data Exchange/Processing Size Estimates

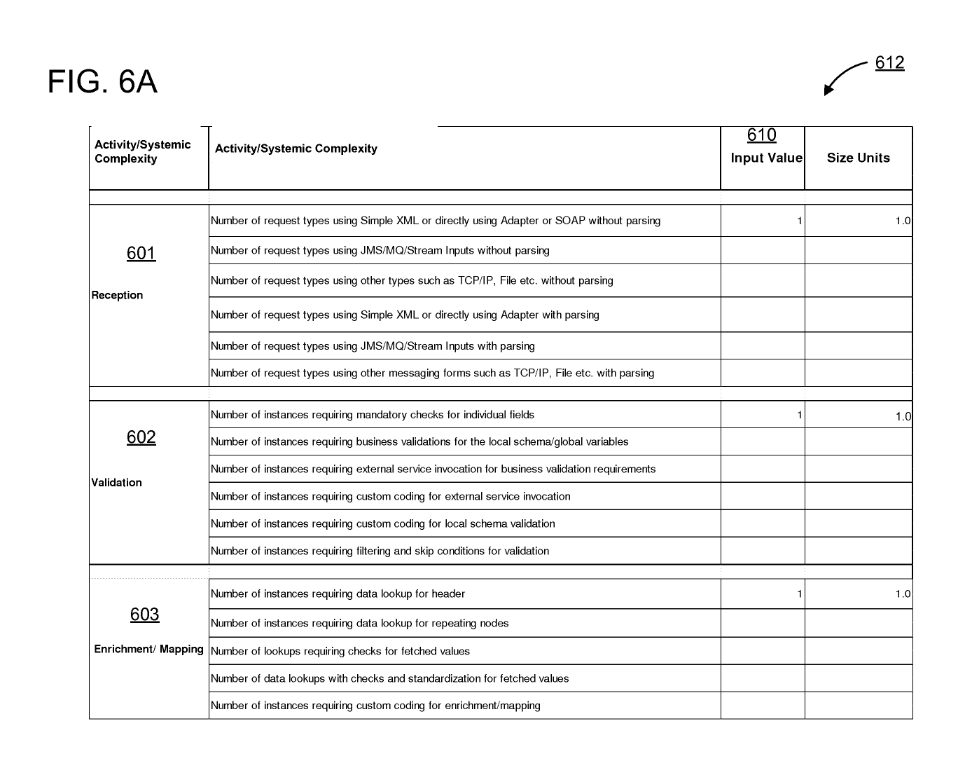

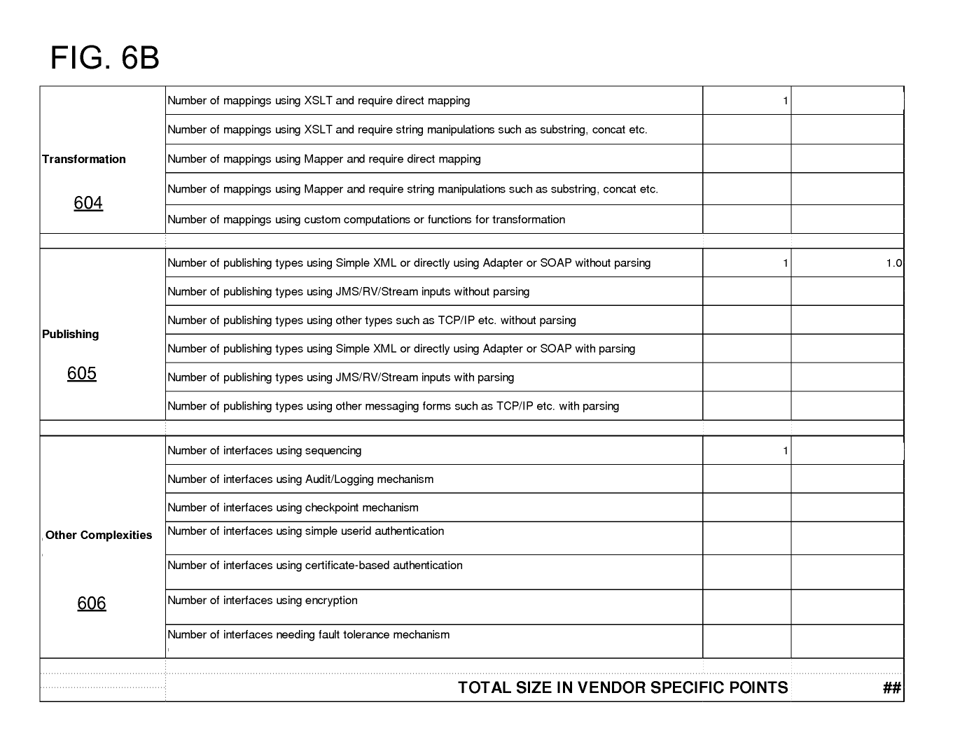

FIGS. 6A-6B are screen shots of a user interface illustrating sizing estimates for a representative EAI project. For convenient illustration, an activity listed a first row for each type in FIGS. 6A-6B is shown as have one instance or occurrence (i.e., Input Value=1). Thus, the total size units (column labeled “Size Units”) for these representative activities are numerically equal to the associated weights. Generally, an input value “X” associated with a weight “W” results in X*W size units. Weights can be determined based on historical data concerning integration capabilities of particular products, or can be determined based on additional investigations. Total project size is a sum of a product of weights times the associated instance. A user can enter numbers of units for one or more activities and the associated weights, or activity numbers and weights can be extracted from data stored in one or more computer readable devices such as RAM or ROM, or a disk drive that can be locally available or available over a wide area network such as the internet.

Size unit estimation can be performed by assessing Activity/System Complexity in some or all of the following categories: Reception, Validation, Enrichment/Mapping, Transformation, and Publishing. Additional activities can be included in a category of Other Complexities. Each of these is discussed in further detail below.

### Estimation Guidelines

For requests requiring publishing to multiple services, each publishing/subscription/outbound data communication is treated as a unique publishing type. For requests requiring multiple types of responses, each type of response is treated as different type of publication. For example, an error message return is different from a return response sent. Error messages and logging mechanisms are counted separately. Multiple occurrences are not treated as different types for reception or publication. For example, if data such as an employee number is input to a service which needs to publish employee details, only one request type is to be accounted irrespective of the number of employee records to be input.

Database calls for fulfillment can be estimated with this approach, but size estimates for building new services are generally excluded. Where inputs are required as numbers of instances, “instances” refers to a “number of occurrences/times” or “frequency of usage” in an application. Each item is preferably counted independently, even if the item is counted elsewhere in some other category. For example, if an interface has XSLT with direct mapping as well as string manipulations, both should be counted, i.e., as an XSLT with direct mapping and as an XSLT with string manipulations.

### Reception

Reception activities 601 are associated with data requests. In order to obtain suitable size estimates, reception is divided into sub-activities that can be of differing complexity. For example, as shown in FIG. 6A, requests that involve simple extended markup language (XML), Java Markup Services (JMS), or MQ streams in which no parsing is required can have weights W=1. Other more complex requests may involve TCP/IP requests without parsing, or XML or JMS requests with parsing can have weights X>W. Other still more complex requests such as TCP/IP requests requiring parsing can be assigned weights Y>X>W.

### Validation

In many cases, received data must be validated. Validation sub-activities 602 include checking individual data fields, or requiring invocation of an external service for validation. In some cases, custom coding must be completed, and filtering or other tests must be applied for validation. Each of the sub-activities can have a different weight, although only one value is shown in FIG. 6A.

### Enrichment/Mapping

Enrichment/Mapping sub-activities 603 can involve extracting data from additional data sources, and in some cases, such lookups can require data checks and standardization of fetched values. In some cases, custom code must be developed for use in these activities. Some or all of these activities can have the same or different weights.

### Transformation

Transformation activities 604 include sub-activities involving direct data mappings using Extensible Stylesheet Language Transformations (XSLT) to produce a new document or data arrangement based on received data. In some cases, data mappings can require string manipulations such as concatenations or substring selection. Higher weights can be assigned to sub-activities requiring string manipulations or custom code development.

### Publishing

Publishing activities 605 includes sub-activities associated with communication between interfaces and applications. Sub-activity weights can be assigned based on whether simple XML or Simple Object Access Protocol (SOAP) is used, or TCP/IP is required.

### Other Complexities

Additional complexities 606 include sub-activities pertaining to data authentication, encryption, and fault tolerances. Other sub-activities are associated with data auditing or logging. In some projects, checkpoint mechanisms are to be implemented so that it can be confirmed that stored data has been updated to aid in recovery in case of a system crash.

### Example 10

### Exemplary Data Exchange/Processing Size Estimates

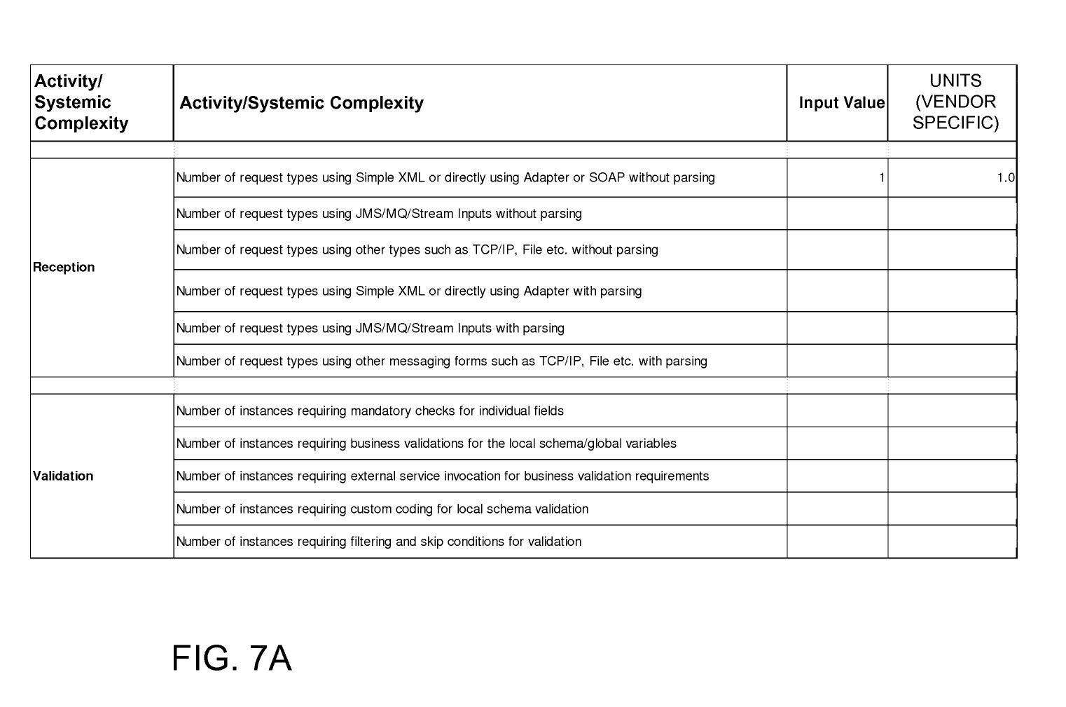

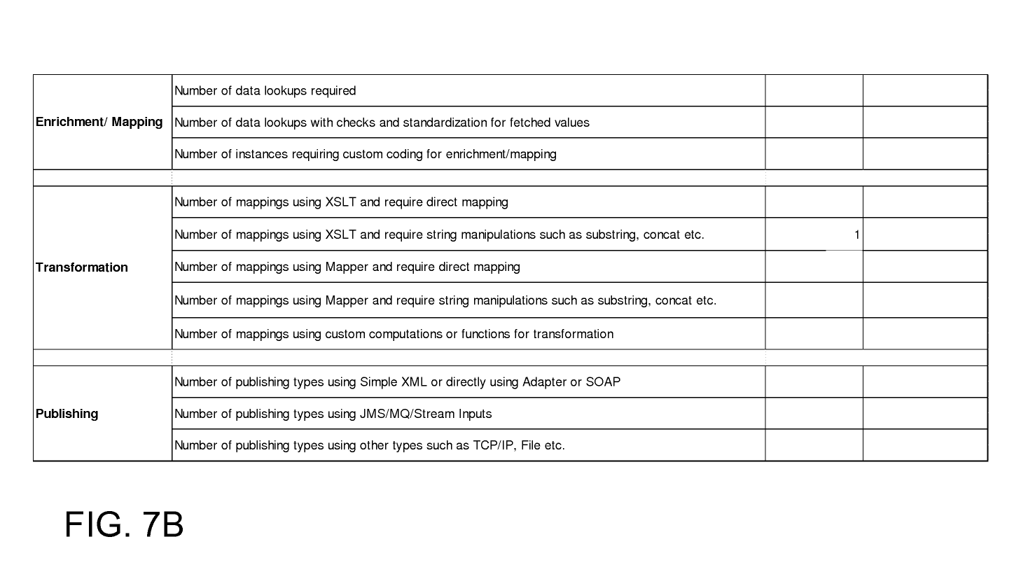

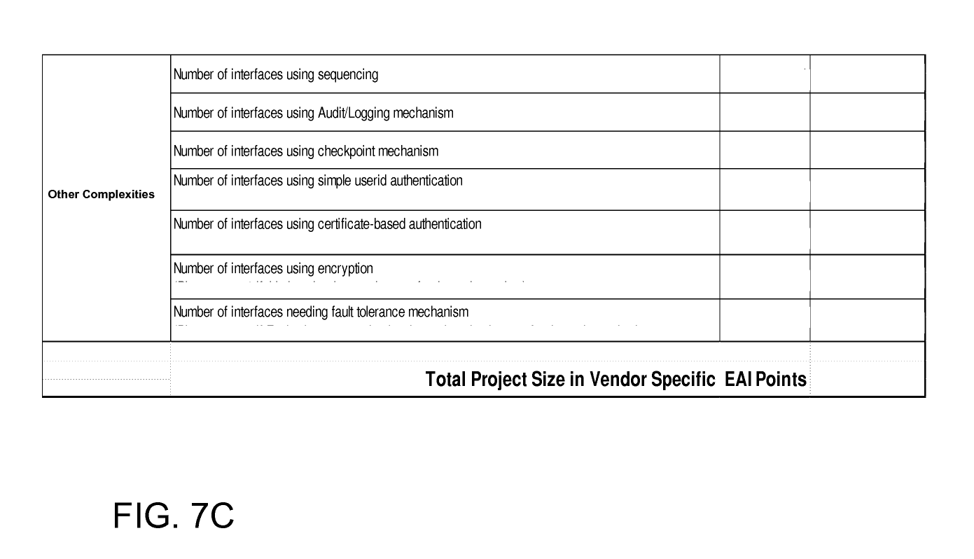

FIGS. 7A-7C illustrate project size estimation for an additional representative project. For convenience, an occurrence for one sub-activity is noted, and the total size for each sub-activity corresponds to an activity weight. The size estimates of FIGS. 6A-6B and FIGS. 7A-7C can be conveniently tabulated using a spreadsheet or other set of computer-executable instructions. Enumerated activity values can be user input in an input value column 610 as shown in FIG. 6A, and sizes displayed in a size unit column 612.

### Example 11

### Representative EAI Project

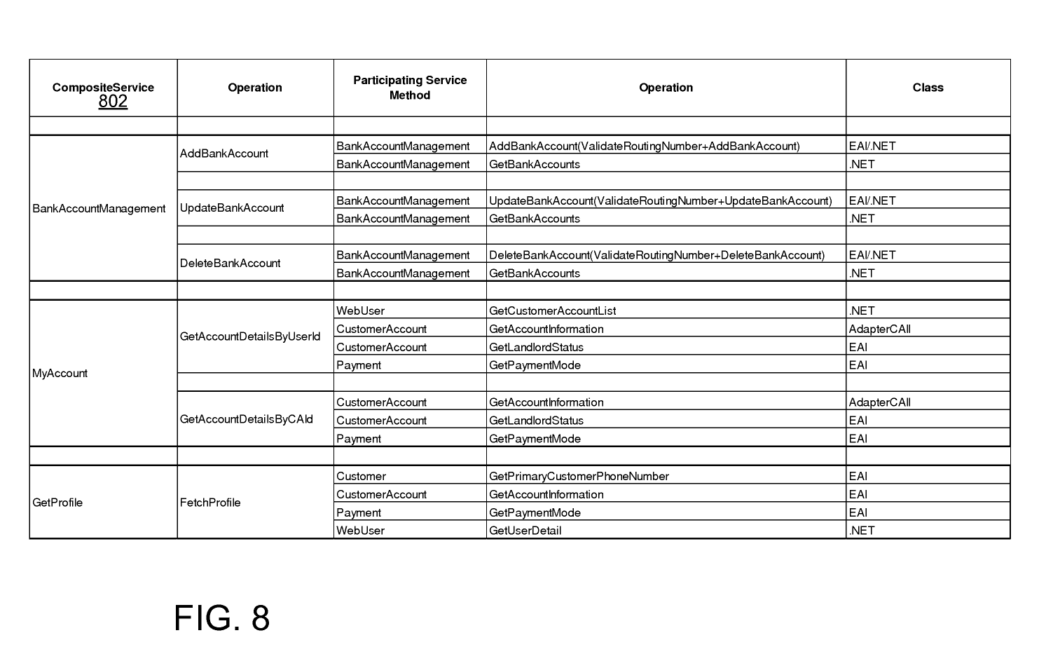

For purposes of illustration, certain aspects of a representative EAI integration project are described. The illustrative project is an electric utility project intended to provide an enhanced customer self-service portal. Business layer and services layers are preferably independent, and certificate based authentication is preferred. In addition, all data exchange schemas are assumed to be simple, i.e., to have less than 15 fields. FIG. 8 list representative business services and operations associated with the project. In FIG. 8, each of the business services is listed in a composite service category 802, and references a particular operation and a service method. For example, the operation AddBankAccount(ValidateRoutingNumber+AddBankAccount) is shown as a BankAccountManagement service. Other operations are similarly listed for MyAccount services (i.e., account management by customers) and for GetProfile services associated with retrieval of customer data. Integration of each of the listed operations can be sized, and project size estimated based on a sum of all these sizes.

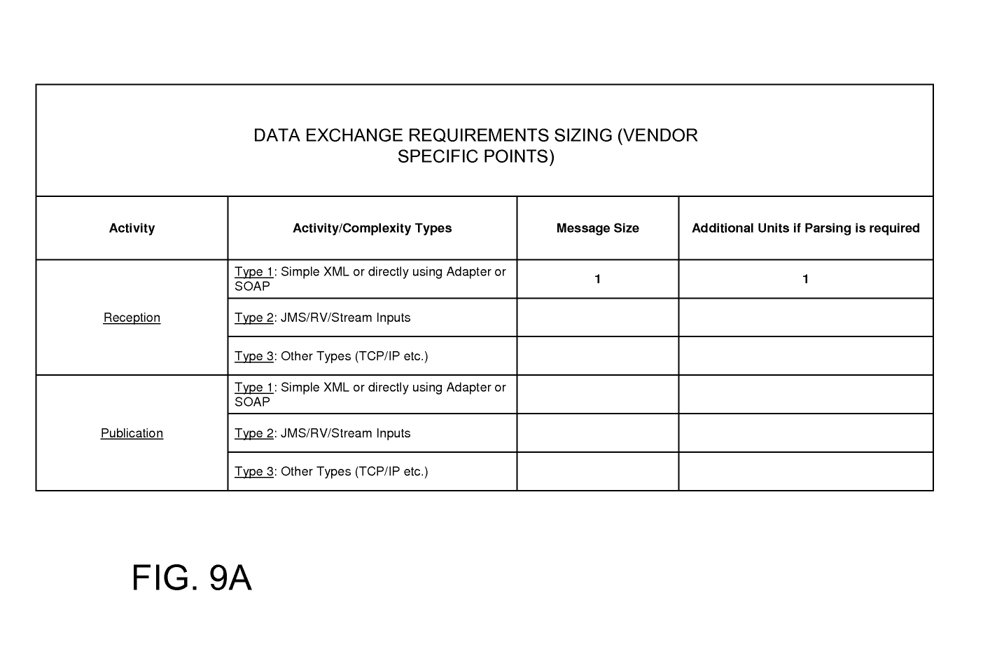

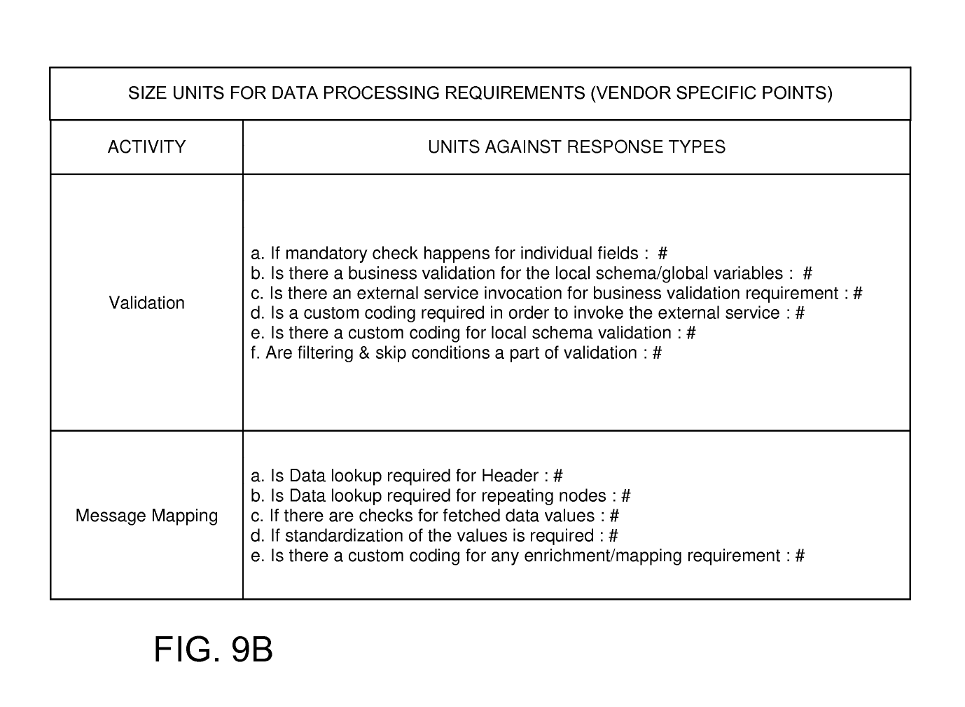

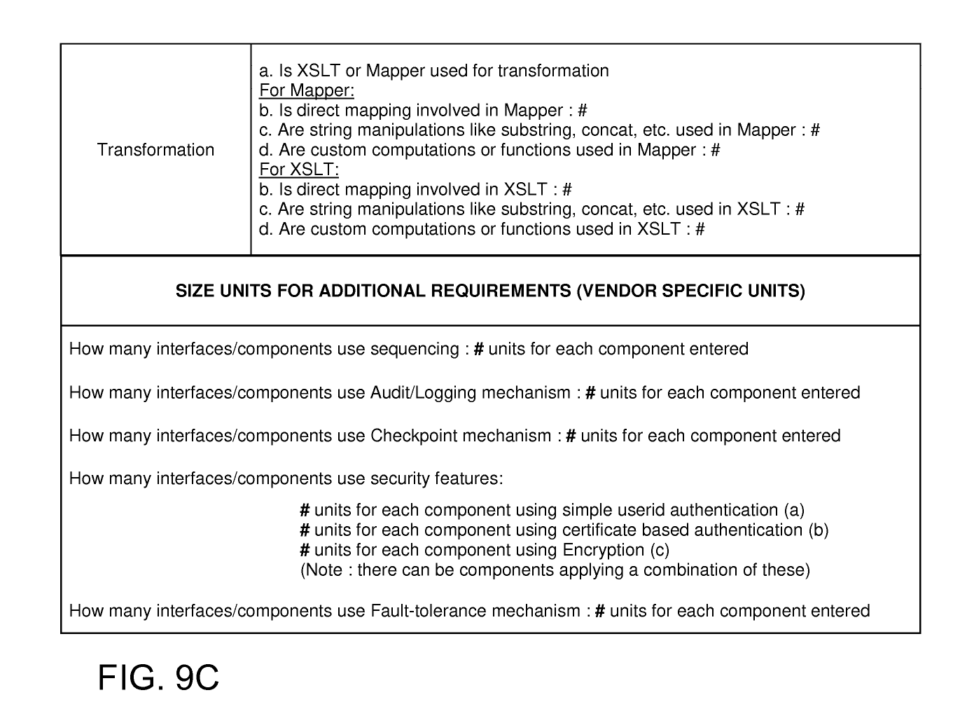

Typical size estimations for Reception and Publication Activities are shown in FIG. 9A. Differing complexities of data input/output are assigned differing weights based on assignments to one of three Activity/Complexity Types. For example, simple XML exchanges are assigned a relatively low weight (1). Additional weight units can be added for any data exchange in which parsing is required. FIGS. 9B-9C illustrate weight assignments for Validation, Message Mapping, and Transformation Activities based on Activity/Complexity Types shown in FIG. 9A. Size requirements associated with Additional Requirements are also listed in FIG. 9C. The example of FIGS. 9A-9C is representative, and such requirements can vary.

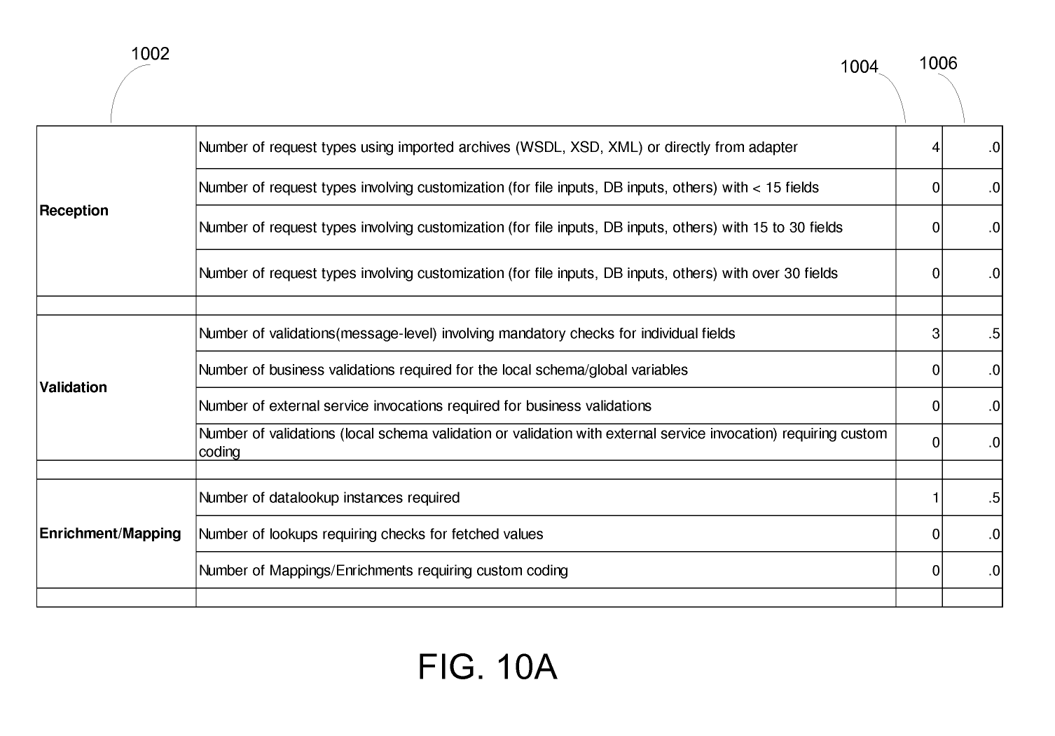

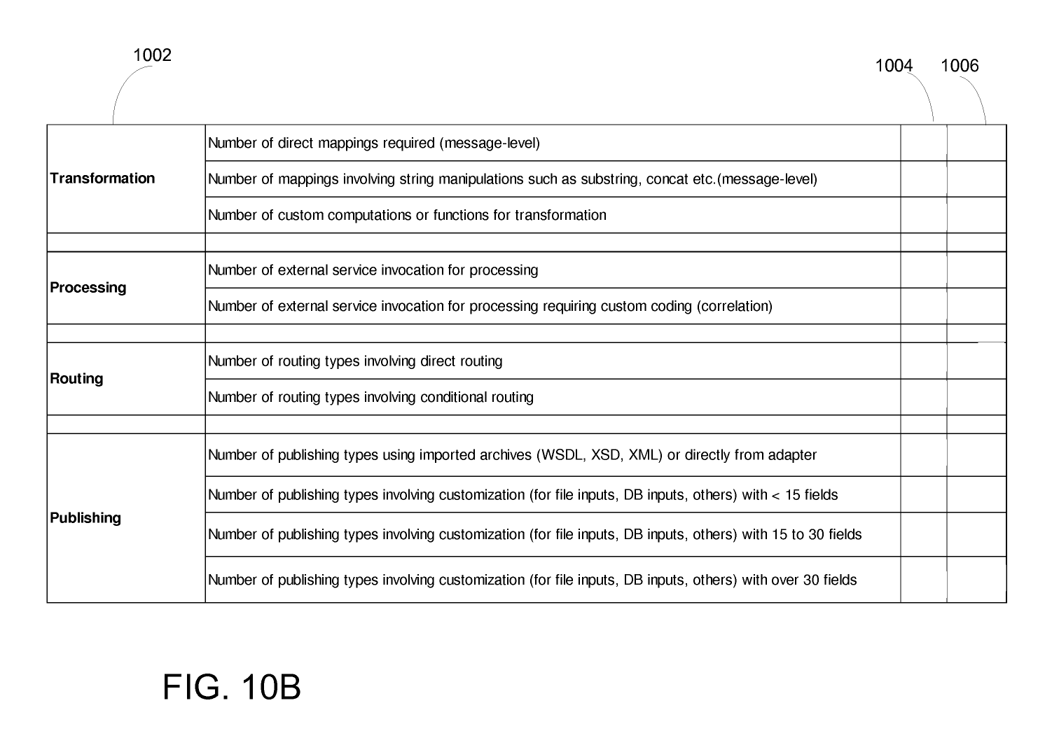

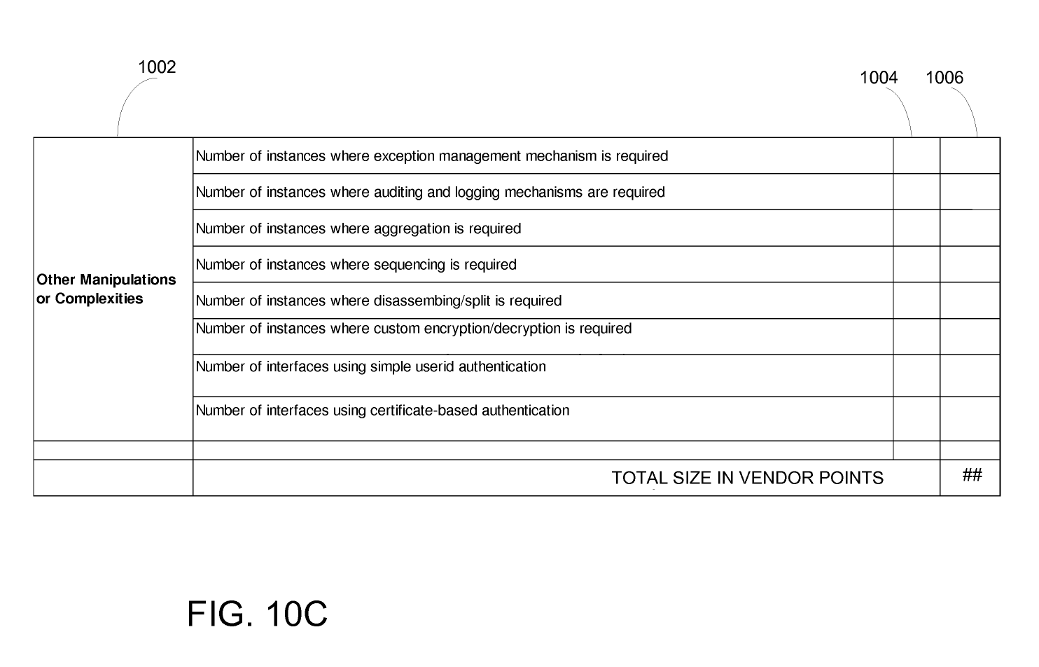

FIG. 10A-10C show a representative sizing worksheet for this project. Each of the operations of FIG. 8 can be evaluated based on the Activity Types column 1002, and suitable entries provided in an Input Number column 1004. For example, as shown in FIG. 10A, four data receptions associated with requests using imported archives (WSDL, XSD, XML) or directly from an adapter are to be added for size estimation. In the view of FIGS. 10A-10C, weights are not displayed, only the products of Input Numbers and weights are shown in a Size Unit column 1006.

### Example 12

### Exemplary Applications

In any of the examples herein, an application to be integrated can be one or more software applications, such as an Enterprise Resource Planning (ERP) software system. An example of an ERP software system is Oracle Applications 11i (Oracle is a registered trademark of Oracle Corporation). Oracle Applications 11i includes modules such as general ledger, payables, receivables, etc. Other software application from one or vendors can also be used.

### Example 13

### Exemplary Standard Weight Album

In any of the examples herein, an album of activities and sub-activities associated typically required in an EAI project can be stored in one or more computer readable media. Along with the list of activities in the album, weights can be assigned to each or some activities or sub-activities In addition, weights can be vendor specific, thereby taking into account the relative complexities associated with integration based on different products.

### Example 14

### Exemplary User Interfaces

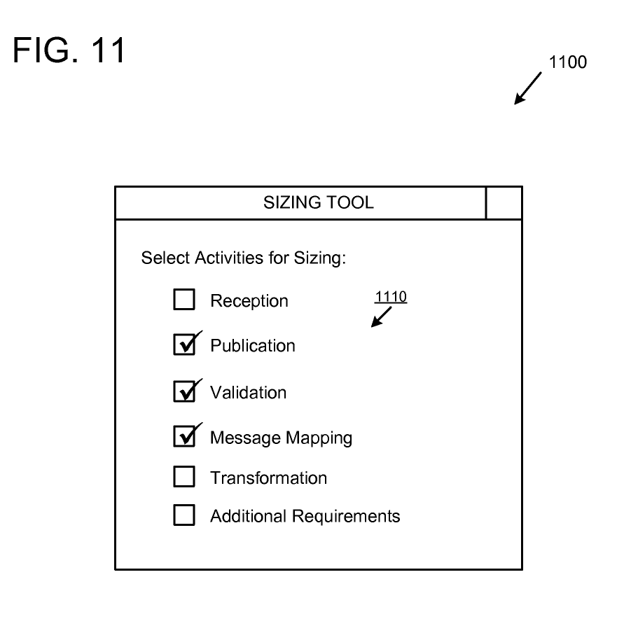

As shown above, user data concerning numbers of activities and associated weights can be provided using a spreadsheet that includes (or can retrieve) weight such as vendor specific weights. In some examples, one or more user interfaces can be provided for selection of an activity list to be considered. For example, as shown in FIG. 11, a user interface 1100 permits selection of one or more activities from an activity list 1110. Typically, all activities are selected along with all sub-activities.

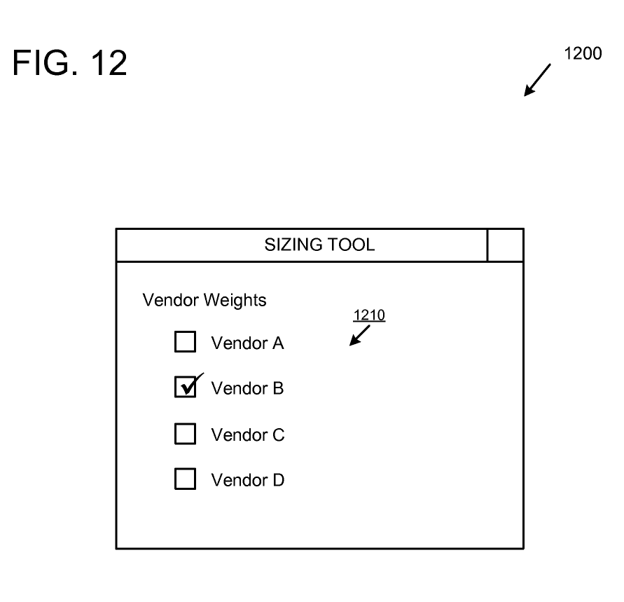

FIG. 12 illustrates a user interface 1200 for selection of weights associated with one or more vendors. In the user interface 1200, a vendor is selected from a vendor list 1210. Other input formats can be used such as, for example, radio buttons, etc. Typically, a user selects a vendor, and associated weights are extracted from a weight album or other database without additional user input.

### Example 15

### Exemplary Computing Environment

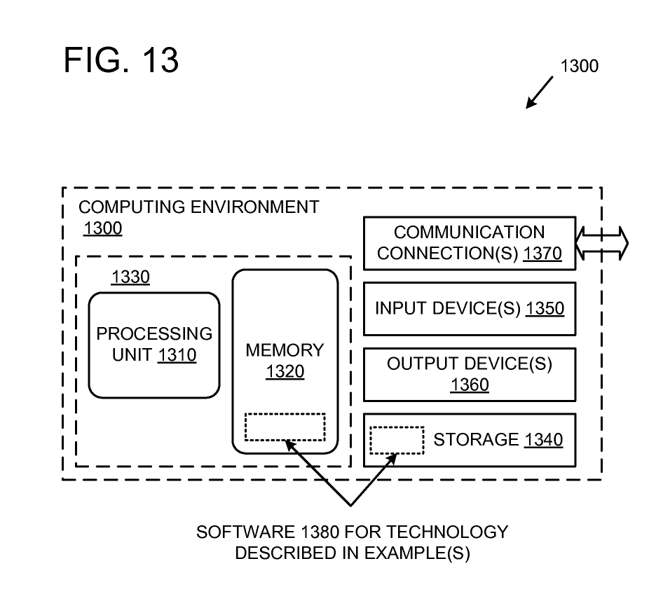

FIG. 13 illustrates a generalized example of a suitable computing environment 1300 in which described examples, embodiments, techniques, and technologies may be implemented. The computing environment 1300 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 13, the computing environment 1300 includes at least one central processing unit 1310 and memory 1320. In FIG. 13, this most basic configuration 1330 is included within a dashed line. The central processing unit 1310 executes computer-executable instructions and may be a real or a virtual processor. In a multi-processing system, multiple processing units execute computer-executable instructions to increase processing power and as such, multiple processors can be running simultaneously. The memory 1320 may be volatile memory (e.g., registers, cache, RAM), non-volatile memory (e.g., ROM, EEPROM, flash memory, etc.), or some combination of the two. The memory 1320 stores software 1380 that can, for example, implement the technologies described herein. A computing environment may have additional features. For example, the computing environment 1300 includes storage 1340, one or more input devices 1350, one or more output devices 1360, and one or more communication connections 1370. An interconnection mechanism (not shown) such as a bus, a controller, or a network, interconnects the components of the computing environment 1300. Typically, operating system software (not shown) provides an operating environment for other software executing in the computing environment 1300, and coordinates activities of the components of the computing environment 1300.

The storage 1340 may be removable or non-removable, and includes magnetic disks, magnetic tapes or cassettes, CD-ROMs, CD-RWs, DVDs, or any other medium which can be used to store information and which can be accessed within the computing environment 1300. The storage 1340 stores instructions for the software 1380, which can implement technologies described herein.

The input device(s) 1350 may be a touch input device, such as a keyboard, keypad, mouse, pen, or trackball, a voice input device, a scanning device, or another device, that provides input to the computing environment 1300. For audio, the input device(s) 1350 may be a sound card or similar device that accepts audio input in analog or digital form, or a CD-ROM reader that provides audio samples to the computing environment 1300. The output device(s) 1360 may be a display, printer, speaker, CD-writer, or another device that provides output from the computing environment 1300.

The communication connection(s) 1370 enable communication over a communication medium (e.g., a connecting network) to another computing entity. The communication medium conveys information such as computer-executable instructions, compressed graphics information, or other data in a modulated data signal.

Computer-readable media are any available media that can be accessed within a computing environment 1300. By way of example, and not limitation, with the computing environment 1300, computer-readable media include memory 1320, storage 1340, communication media (not shown), and combinations of any of the above.

### Example 16

### Exemplary Automated Methods

Any of the methods described herein can be performed via one or more computer-readable media (e.g., storage or other tangible media) having computer-executable instructions for performing (e.g., causing a computing device or computer to perform) such methods. Operation can be fully automatic, semi-automatic, or involve manual intervention.

### Example 17

### Exemplary Combinations

The technologies of any example described herein can be combined with the technologies of any one or more other examples described herein.

### Example 18

### Exemplary Alternatives

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A method, implemented at least in part by a computing device, for determining a build size of an application integration project, the method comprising:
enumerating a number of inter-application data exchange instance definitions associated with at least two applications to be integrated;
determining complexity factors for the inter-application data exchange instances; and
calculating the build size of the application integration project based at least on the number of inter-application data exchange instance definitions and the associated complexity factors.

2. The method of claim 1, wherein calculating the build size of the application integration project is based on a summation of products of numbers of inter-application data exchange instance definitions and weights associated with the complexity factors.

3. The method of claim 1, further comprising:
characterizing one or more of the inter-application data exchange instance definitions as at least one of a reception exchange instance definition or a publishing exchange instance definition.

4. The method of claim 1, further comprising:
enumerating inter-application data processing instance definitions associated with the integration;
determining complexity factors for the inter-application data processing instance definitions; and
calculating the build size of the application integration project based at least on the number of inter-application data processing instance definitions and the associated complexity factors.

5. The method of claim 4, further comprising:
characterizing one or more of the inter-application data processing instance definitions as at least one of a validation instance definition, a transformation instance definition, or a data enhancement instance definition.

6. The method of claim 5, wherein calculating the build size of the application integration project is based on a summation of products of numbers of inter-application data exchange instance definitions, numbers of inter-application data processing instance definitions, and weights associated with the respective complexity factors.

7. The method of claim 6, further comprising:
enumerating systemic requirements associated with the integration;
determining complexity factors for the systemic requirements; and
calculating the build size of the application integration project based on the enumerated systemic requirements and the associated complexity factors.

8. One or more computer-readable media comprising computer-executable instructions for causing the computing device to perform the method of claim 7, wherein calculating the build size of the application integration project is based on a summation of products of numbers of inter-application data exchange instance definitions, numbers of inter-application data processing instance definitions, numbers of systemic requirements and weights associated with the respective complexity factors and wherein at least one or more weights for systemic requirements are based on data encryption, data authentication, data sequencing, error handling, event handling, data splitting, and data merging.

9. The method of claim 8, further comprising extracting weights from a standard weight album, wherein the standard weight album contains a pre-defined plurality of weights available for at least one of the inter-application data exchange instance definitions, the inter-application data processing instance definitions, and the enumerated systemic requirements, wherein the pre-defined weights are based on a degree of implementation complexity.

10. A sizing framework, implemented at least in part by a computing device, for determining an size of an enterprise application integration project, the sizing framework comprising:
a repository of one or more activity categories and associated sub-categories, wherein each of the one or more associated sub-categories has a corresponding weight; and
a repository of data exchange interfaces associated with the applications to be integrated.

11. The sizing framework of claim 10, wherein the activity categories are based on data exchanges, data processing associated with the data exchanges and systemic requirements associated with the integration.

12. The sizing framework of claim 10, wherein the activity categories include two or more of data reception, data publishing, data transformation, data validation, and data enrichment.

13. The sizing framework of claim 12, wherein sub-activities associated with data reception are based on a data format associated with a data request.

14. The sizing framework of claim 13, wherein the data formats include XML or other data streams.

15. The sizing framework of claim 13, wherein further sub-activities associated with data reception and data formatting include metadata construction and number of composite fields.

16. The sizing framework of claim 13, wherein sub-activities associated with data transformation are based on string manipulations associated with the data transformation.

17. A computer implemented interface for estimating a build size of an enterprise application integration project, comprising:
a data category display area configured to display an activity category list that includes categories associated with data reception, data publishing, data transformation, and validation;
a data input area including data input areas configured to receive indications of numbers of activities in each activity category; and
an output data area configured to display a build size based on the numbers of activities.

18. The interface of claim 17, further comprising a display area configured to display activity complexity types.

19. The interface of claim 18, further comprising an activity output area configured to display a build size associated with each of the activity complexity types.

20. The interface of claim 19, wherein the activities comprise data routing and data enrichment.

21. The interface of claim 19, wherein the activity output area is configured to display a build size associated with each of the activity complexity types based on a product of numbers of activities of each type and weights assigned to the activity types.
